(19) United States
(12) Patent Application Publication
(10) Pub. No.: US 2004/0123280 A1
(43) Pub. Date: Jun. 24, 2004

(54) Dependence compensation for sparse computations

(76) Inventors: Gautam B. Doshi, Santa Clara, CA (US); Dattatraya Kulkarni, Santa Clara, CA (US); Anthony J. Roide, Phoenix, AZ (US); Antonio C. Valles, Gilbert, AZ (US)

Correspondence Address: Robert A. Burtzlaff, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/325,169

(22) Filed: Dec. 19, 2002

(51) Int. Cl. G06F 9/45

(52) U.S. Cl. 717/161; 717/150

(57) ABSTRACT

An embodiment of a compiler technique for decreasing sparse matrix computation runtime parallelizes loads from adjacent iterations of unrolled loop code. A dependence check code is statically inserted to identify dependence between store and load dynamically, and information is passed to a code scheduler for scheduling independent parallel computation and potentially dependent computations at suitable latencies.

### FIELD OF THE INVENTION

The present invention relates to compilers for computers. More particularly, the present invention relates to techniques to enhance performance in the absence of static disambiguation of indirectly accessed arrays and pointer dereferenced structures.

### BACKGROUND OF THE INVENTION

Optimizing compilers are software systems for translation of programs from higher level languages into equivalent object or machine language code for execution on a computer. Optimization generally requires finding computationally efficient translations that reduce program runtime and eliminating unused generality. Such optimizations may include improved loop handling, dead code elimination, software pipelining, better register allocation, instruction prefetching, or reduction in communication cost associated with bringing data to the processor from memory.

Certain programs would be more useful if appropriate compiler optimizations are performed to decrease program runtime. One such program element is a sparse matrix calculation routine. Commonly, an n-dimensional matrix can be represented by full storage of the value of each element in the memory of the computer. While appropriate for matrices with many non-zero elements, such matrices can consume substantial computational resources. For example, a 10,000 by 10,000 2-dimensional matrix would require space for 100,000,000 distinct memory elements, even if only a fraction of the matrix elements are non-zero. To address this storage problem, sparse matrix routines appropriate for matrices constituted mostly of zero elements have been developed. Instead of simultaneously storing in computer memory every element value, whether it is zero or non-zero, only integer indices to the non-zero elements, along with the element value itself, are stored. This has the advantage of greatly decreasing required computer memory, at the cost of increasing computational complexity. One such computational complexity is that array elements must be indirectly accessed, rather than directly determined as an offset from the base by the size of the array type, e.g. for each successive element of an integer array, the address is offset by the size of an integer type object.

Common compiler optimizations for decreasing runtime do not normally apply for such indirectly accessed sparse matrix arrays, or even straight line/loop code with indirect pointer references, making suitable optimization strategies for such types of code problematic. For example, pipelining a loop often requires that a compiler initiate computations for the next iteration while scheduling computation for the current loop iteration. Most often this requires performing data accesses (loads) for the required datum for the next iteration before the computational results from the current iteration have been saved to memory (stored). But such a transformation can only be performed if the compiler is able to determine that the loads for the next iterations do not access the same datum as that stored by the current iteration - or in other words, the compiler needs to be able to statically disambiguate the memory address of the load from the memory address of the store. However, statically disambiguating references to indirectly accessed arrays is difficult. A compiler's ability to exploit a loop's parallelism is therefore significantly limited when there is a lack of static information to disambiguate stores and loads of indirectly accessed arrays.

Typically a high level language loop specifies a computation to be performed iteratively on different elements of some organized data structures (e.g. arrays, structures, records, etc). Computations in each iteration typically translate to loads (to access the data), computations (to compute on the data loaded) and stores (to updated the data structures in memory). Achieving higher performance often entails performing these actions related to different iterations concurrently. To do so, loads from successive iterations have to be performed before stores from current iterations. When the data structures being accessed are done so indirectly (either through pointers or via indirectly obtained indices) the dependence between stores and loads is dependent on data values (of pointers or indices) produced at run time. Therefore at compile time there exists a “probable” dependence. Probable store-to-load dependence between iterations in a loop prevents the compiler from hoisting the next iteration's loads and the dependent computations above the prior iteration stores. The compiler cannot assume the absence of such dependence, since ignoring such a probable dependence (and hoisting the load) will lead to compiled code that produces incorrect results.

Accordingly, conventional optimizing compilers must conservatively assume the existence of store to load (or vice versa) dependence even when there might not be any dependence. Compilers are often not able to statically disambiguate pointers in languages such as C to determine if they may point to the same data structures. This prevents most efficient use of speculation mechanisms that allow instructions from a sequential instruction stream to be reordered. Conventional out-of-order uni-processors cannot reorder memory access instructions until the addresses have been calculated for all preceding stores. Only at this point will it be possible for out-of-order hardware to guarantee that a load will not be dependent upon any preceding stores

Even if advanced architecture processors capable of breaking store to load dependence are targeted, use of advanced load instructions to break the store to load dependence and hoist the load and dependent computations above the store come with performance penalties. For example, when compiling for execution on Itanium processors, the compiler will have to use chk.a instruction to check the store to load dependence. However, the penalty when chk.a fails (i.e. when the store collides with the load) is very high, eliminating the benefit of advancing the loads, even when a small fraction of the load-store pairs collide.

### BRIEF DESCRIPTION OF THE DRAWINGS

FIG. 1 illustrates operation of dependence check code

FIG. 2 illustrates a general procedure for statically disambiguating references to indirectly accessed arrays, and

FIG. 3 illustrates application of the general procedure to a sparse array computation.

### DETAILED DESCRIPTION OF THE INVENTION

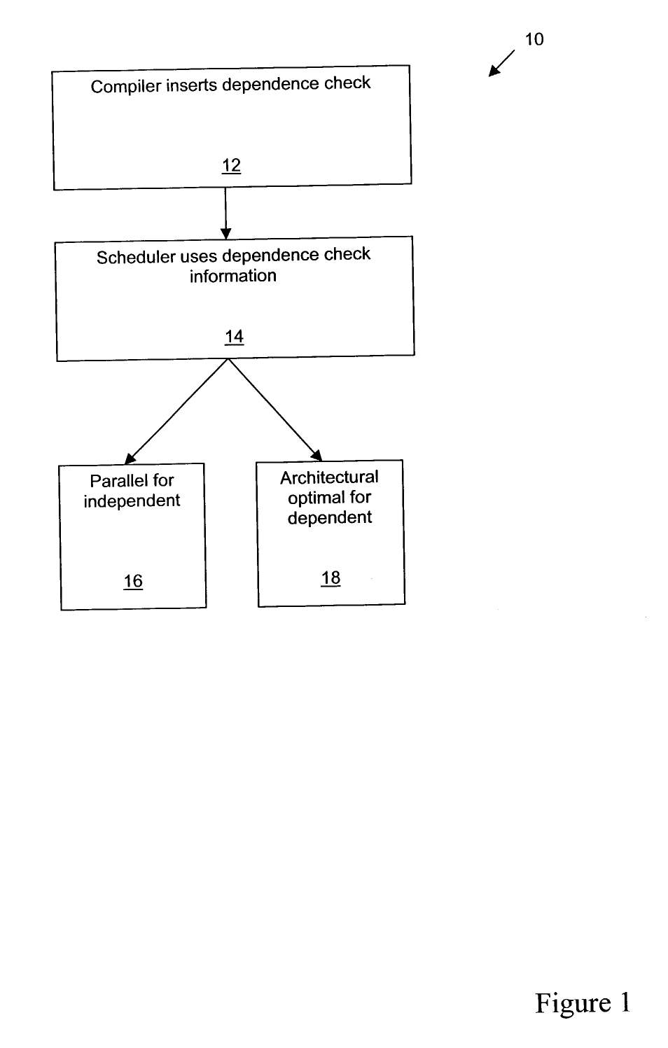

As seen with respect to the block diagram of FIG. 1, the present invention utilizes a computer system operating to execute compiler software. The compiler software can be stored in optical or magnetic media, and loaded for execution into memory of computer system. In operation, the compiler performs procedures to optimize a high level language for execution on a processor such as the Intel Itanium processor or other high performance processor. As seen in FIG. 1, an architecture independent compiler process 10 is used to generate compiled code that dynamically detects store to load dependencies at run-time. To accomplish this, as seen with respect to the software module of block 12, dependence check code is inserted to dynamically disambiguate stores and loads to indirectly accessed arrays. The dependence check code is used to compensate for the lack of static information to disambiguate between stores and loads at compile time. This information identifying that certain pairs of stores and loads that are independent and other pairs are rarely dependent is passed to the code-scheduler (block 14). The code scheduler uses the information to schedule the independent and the rarely dependent loads/stores differently. The independent computations can be scheduled in parallel (block 16), while the rarely dependent loads (and dependent computations) can be scheduled at “architectural” latencies (block 16) so that overall code schedule time is not lengthened. As a result, the compiled code executes faster than the compiled code generated without using process 10, both in the presence and absence of store to load dependencies. Further, the compiled code generated using the proposed technique produces correct result when store to load dependencies do exist.

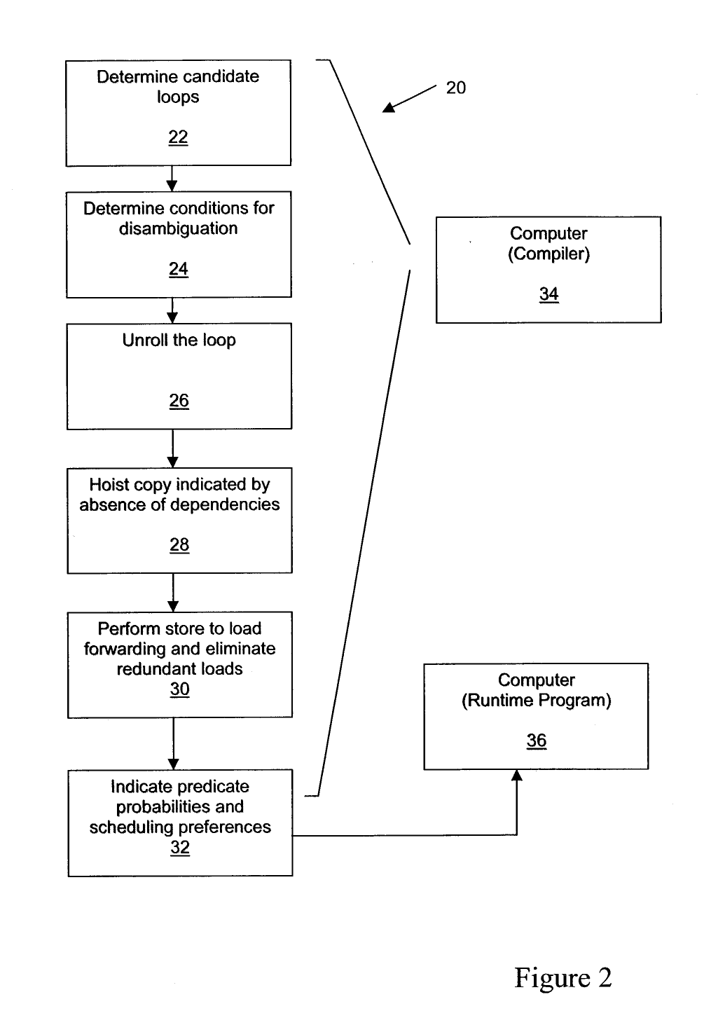

Generally, FIG. 2 details compiler process modifications 20 necessary to support the foregoing functionality. As seen in FIG. 2, a computer 34 executes a compiler program performing block or module organized procedures to optimize a high level language for execution on a target processor. The compiler process 20 includes a determination (block 22) of candidate loops where the technique should be applied. Generally, these are loops with indirectly accessed arrays or indirect pointer references. In addition, candidate loops should have a low “operation density”. For example, if a loop has a height of 14 cycles, and maximum operation slots of 14*6=84 (assuming a 6 issue machine), and the loop has only 5 operations, then the operation density is 5/84. In general, this can be any heuristic that determines if the machine resources are under utilized. After candidate loops have been identified, the sufficient conditions for disambiguation must be determined by insertion of dependence-check code that compares indices (block 24). In certain cases, however, if base addresses of arrays themselves can also not be disambiguated then computed addresses of loads and stores would also have to be compared.

Continuing the process, the loop is first unrolled (block 26) and one copy is hoisted (block 28) after an indicated absence of dependences. Hoisting out of the loop is stopped if the presence of dependences is indicated. Store to load forwarding (block 30) is performed to eliminate redundant loads, and predicate probabilities are indicated to the scheduler (block 32), permitting processing of the code at machine latencies for hoisted copy of the loop and “architectural” latencies for the non hoisted copy of the loop during runtime of the compiled program on a runtime computer 36. As will be appreciated, while this process is most effective in the context of loops with indirectly accessed arrays, it can be more generally applied in the context of straight-line code and loops with indirect pointer references.

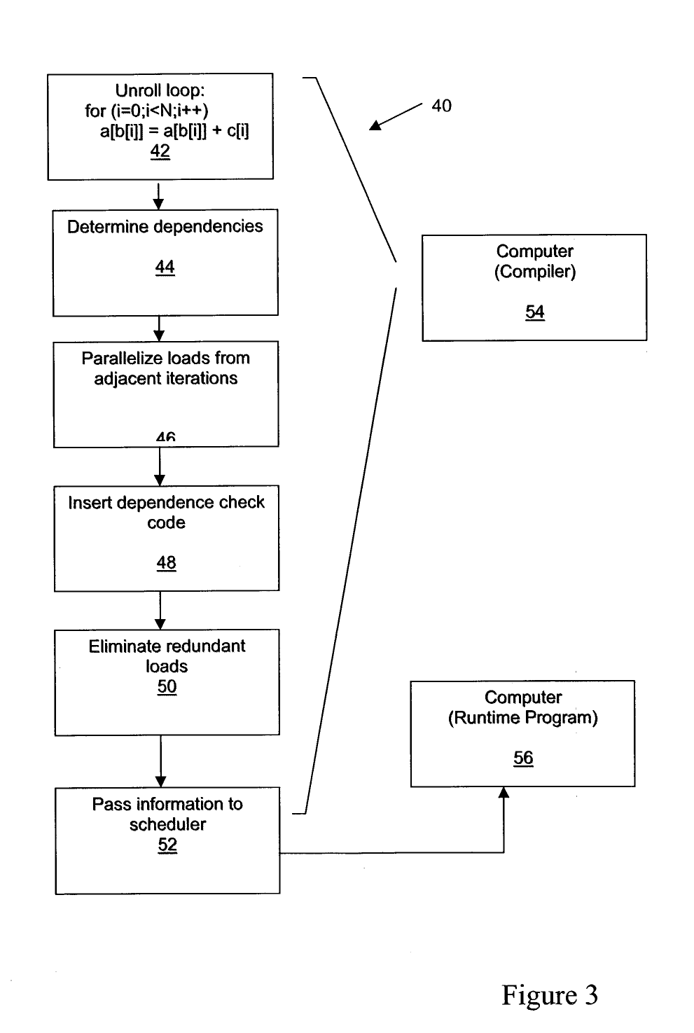

To more specifically understand one embodiment of the foregoing process as implemented on a computer/compiler combination 54, FIG. 3 indicates application of a procedure 40 to a code snippet for a gather vector and add calculation commonly employed in sparse matrix computation.

The following original loop is processed by the compiler:

for (i=0; i<N; i++)

a[b[i]]=a[b[i]]+c[i];

Ordinarily, there is insufficient information to determine at compile-time whether loop iterations are dependent or independent. Consecutives iterations of the original loop are serialized for running on computer 36, because of lack of information at compile-time to disambiguate the a[b[i]] reference from a[b[i+1]] reference in the following iteration, even though loops indirectly accessing sparse matrix arrays tend to access distinct elements in the loop. The dependences occur once in several iterations, if at all.

Taking advantage of typical access patterns in sparse matrix array computations and parallel processing resources of the target machine can substantially improve the performance of such applications. To demonstrate the difficulties in scheduling loops with stores and loads with probable dependence, consider the unrolled version of the original loop using conventional compiler processing techniques (parallelism has been indicated by juxtaposing code in the same row):

Unrolled Loop

| | |
|---|---|
| (A) | (B) |

for (i=0; i<N; i+2) {

| | |
|---|---|
| 1 bi = b [i]; | bip1 = b [i+1]; |
| 2 abi = a [bi]; | |
| 3 ti = abi+c [i]; | |
| 4 a [bi] = ti; | |
| 5 | abip1 = a [bip1]; |
| 6 | tip1= abip1+c [i+1]; |
| 7 | a [bip1] = tip1; |

}

As can be seen above, only the loads of b[i] can be executed in parallel. However, the load of a[bip1] and dependent computation must be scheduled after the store of a[bi]. This limits the realized parallelism even when the load of a[bip1] is independent of the store of a[bi].

Using the process detailed in FIG. 3, the original example loop above has been transformed below:

Transformed Loop

| | |
|---|---|
| (A) | (B) |

for (i=0; i<N; i+2) {

| | |
|---|---|
| 1 bi = b [i]; | bip1 = b [i+1]; |

| | |
|---|---|
| 2 abi = a [bi]; | abip1 = a [bip1]; |
| 3 ti = abi+c [i]; | tip1= abip1+c [i+1]; |
| 4 if (bi==bip1) tip1 = ti+c [i+1]; | |
| 5 a [bi] = ti; | a [bip1] = tip1; |

}

The compiler transforms the loop of the example by unrolling the loop to expose instruction level parallelism (block 42), and determining that dependencies between stores to loads from adjacent iterations are rare (block 44).

Loads from adjacent iterations are parallelized (block 46) by moving or hoisting the load and computation on a[b[i+1]] above the stores to a[b[i]] (step 2B) and dependence-check code is inserted (block 48) in step 4A to check whether there is a dependence between store and load (when bi=bip1). The compiler also generates code to redo the computations when dependence exists.

As seen in block 50 and the above code example, the load a[b[i+1]] is eliminated when bi=bip1. The compiler passes information to the code-scheduler (block 52) so that computations in 4A are rarely executed. The code-scheduler uses this information to schedule independent computations in parallel at machine latencies, and the rarely dependent loads (and dependent computations) at “architectural” latencies (so that the rarely executed sequence of instructions do not lengthen the overall code schedule).

The performance benefit of the transformed loop is clear when the number of cycles needed to execute the original loop and the transformed loop are compared. In the original loop consecutive iterations are serialized, because there is a lack of information at compile-time to disambiguate a[b[i]] reference from a[b[i+1]] reference of the next iteration. If the load of a[b[i]] takes 9 machine clocks and the add with c[i] takes 5 clocks, then each iteration of the original loop requires 14 clocks to produce a result to store in array a.

The transformed loop has exploited the loop's parallelism by disambiguating the store-to-load dependence. Now the critical path through the transformed loop is 2A, 3A, 4A, 5B and the dependence would be from the stores (5A/5B) to the loads of the next iterations (2A/2B). The loop speed would then be 9 clock for 2A, 5 clock for 3A, 5 clock for 4A=19 clocks OR 9.5 clocks per iteration.

Further, since the compiler can signal the predicate probabilities which in this case are the likelihood of a[b[i]] references in adjacent iterations accessing the same memory location. In other words, the optimizer indicates that a store to a[b[i]] and a load to a[b[i+1]] in the adjacent iteration are unlikely to be the same. Doing so enables the scheduler to then schedule 4A only 1 clock (not 5) after 3A and 5B only 1 clock (not 5) after 4A (but 5 clock after 3B). The loop speed would then be 9 clock for 2A, 5 clock for 3A=14 clocks OR 7 clocks per iteration (since there is the extra latency of the comparison bi!=bip1 for the computations on the B column, 5B might be delayed a clock or two after 5A thus reducing loop speed by a clock or two). In effect, the technique improved the example code by about 2× performance gain during runtime on computer 56 for the common case of b[i]!=b[i+1].

Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A method comprising:
parallelizing loads from adjacent iterations of unrolled loop code;
transforming unrolled loop code by inserting a dependence check code to identify dependence between store and load; and
passing information to a code scheduler for scheduling independent parallel computation at a machine latency when checked code is not dependent.

2. The method of claim 1, further comprising determining a candidate loop code for unrolling that supports indirectly accessed arrays.

3. The method of claim 1, further comprising determining a candidate loop code for unrolling that supports indirect pointer references.

4. The method of claim 1, further comprising scheduling independent parallel computation at an architectural latency when checked code is not dependent.

5. The method of claim 1, further comprising hoisting a copy determined to have no dependencies.

6. The method of claim 1, further comprising store to load forwarding.

7. The method of claim 1, further comprising indicating predicate probabilities to the code scheduler.

8. An article comprising a computer-readable medium which stores computer-executable instructions, the instructions causing a computer to:
parallelize loads from adjacent iterations of unrolled loop code;
transform unrolled loop code by inserting a dependence check code to identify dependence between store and load; and
pass information to a code scheduler for scheduling independent parallel computation at a machine latency when checked code is not dependent.

9. The article comprising a computer-readable medium which stores computer-executable instructions of claim 8, wherein the instructions further cause a computer to determine a candidate loop code for unrolling that supports indirectly accessed arrays.

10. The article comprising a computer-readable medium which stores computer-executable instructions of claim 9, wherein the instructions further cause a computer to determine a candidate loop code for unrolling that supports indirect pointer references.

11. The article comprising a computer-readable medium which stores computer-executable instructions of claim 8, wherein the instructions further cause a computer to schedule independent parallel computation at an architectural latency when checked code is not dependent.

12. The article comprising a computer-readable medium which stores computer-executable instructions of claim 8, wherein the instructions further cause a computer to hoist a copy determined to have no dependencies.

13. The article comprising a computer-readable medium which stores computer-executable instructions of claim 8, wherein the instructions further cause a computer to initiate store to load forwarding.

14. The article comprising a computer-readable medium which stores computer-executable instructions of claim 8, wherein the instructions further cause a computer to indicate predicate probabilities to the code scheduler.

15. A system for optimizing software comprising:
an unrolling module for parallelizing loads from adjacent iterations of unrolled loop code and transforming unrolled loop code by inserting a dependence check code to identify dependence between store and load; and
a code scheduler for scheduling independent parallel computation when checked code is determined to be not dependent by the unrolling module.

16. The method of claim 15, further comprising a module for determining a candidate loop code that supports indirectly accessed arrays to pass to the unrolling module.

17. The method of claim 15, further comprising a module for determining a candidate loop code that supports indirect pointer references to pass to the unrolling module.

18. The method of claim 15, further comprising a module for determining a candidate loop code that schedules independent parallel computation at a machine latency when checked code is not dependent.

19. The method of claim 15, further comprising a module for determining a candidate loop code that schedules independent parallel computation at an architectural latency when checked code is not dependent.

20. The method of claim 15, further comprising store to load forwarding by the unrolling module.

21. The method of claim 15, wherein the unrolling module indicates predicate probabilities to the code scheduler.

22. A method for processing indirectly accessed arrays comprising:
transforming unrolled loop code for array access by inserting a dependence check code to identify dependence between store and load; and
passing information to a code scheduler for scheduling independent parallel computation when checked code is not dependent.

23. The method of claim 22, further comprising determining a candidate loop code for unrolling that supports sparse matrix computation.

24. The method of claim 22, further comprising determining a candidate loop code for unrolling that has a low operation density.

25. The method of claim 22, further comprising scheduling architecturally determined processing of rarely dependent loads identified by the dependence check code.

26. The method of claim 22, further comprising hoisting a copy determined to have no dependencies.

27. The method of claim 22, further comprising store to load forwarding.

28. The method of claim 22, further comprising indicating predicate probabilities to the code scheduler.
